(19) United States
(12) Patent Application Publication
(10) Pub. No.: US 2008/0127742 A1
(43) Pub. Date: Jun. 5, 2008

(54) Pressure sensor having a check valve

(76) Inventors: Andre Mueller, Gerlingen (DE); Reinhold Herrmann, Stuttgart (DE); Christian Hauer, Remshalden (DE); Holger Seeg, Wixom, MI (US); Robert Hill, Waterford, MI (US); Martin Warken, Haiterbach (DE); Markus Reinhard, Kornwestheim (DE); Marc Koltermann, Stuttgart (DE)

Correspondence Address: KENYON & KENYON LLP, ONE BROADWAY, NEW YORK, NY, 10004, US

(21) Appl. No.: 11/634,289

(22) Filed: Dec. 4, 2006

(51) Int. Cl. G01L 7/00

(52) U.S. Cl. 73/756

(57) ABSTRACT

A pressure sensor or pressure switch for detecting an overpressure or underpressure, in particular on a pressure accumulator. The pressure sensor includes a housing, in which a first connecting piece is disposed. The housing includes a check valve and a second connecting piece for a pressure source.

### BACKGROUND INFORMATION

A plug connection for media-carrying lines is described in German Patent No. DE 102 40 130.6-16. A plug element includes at least one connection point, a sleeve-shaped element made of a first material, movable in a locking direction and an unlocking direction, being accommodated in a form-locking manner on a plug element having a springy tab. If piezo actuators are used in fuel injection systems, which, for example, actuate fuel injectors for self-igniting combustion engines, it may be necessary to maintain a residual pressure of a few bar in the fuel return system of such a combustion engine. In fuel return systems used to date, whether for externally ignited combustion engines or for self-igniting combustion engines, the fuel flows from the return system directly into the fuel tank, in which only an ambient pressure level prevails.

In many pressure systems having pressure accumulators and pressure or vacuum sources, pressure sensors or pressure switches for monitoring the pressure level and check valves for maintaining a pressure level are used today. In braking systems of vehicles, for example, brake boosters are normally used today. On brake boosters having pressure monitoring, generally two separate components are hooked up or connected to the brake booster. This is on the one hand a check valve, which connects the vacuum side of the pressure booster (e.g. of a brake booster) to a vacuum source, and on the other hand a pressure sensor or pressure switch, which is used to monitor the vacuum prevailing in the pressure accumulator (e.g. brake booster).

In pressure accumulators used to date, e.g. brake boosters, which work according to the underpressure principle, their dimensioning turns out to be relatively large. In order to reduce the dimensioning of a pressure accumulator, such as e.g. of a brake booster, or to ensure that the required underpressure level is available at any time, additionally the above-mentioned components such as pressure sensor or pressure switch or check valve are mounted on the pressure accumulator so that in the case of need additional underpressure is available. Such brake booster assemblies, which are equipped with a separate check valve and a pressure sensor, are, in addition to the mentioned high space requirement, further associated with higher production costs as well as a relatively high assembly and manufacturing expenditure.

This scenario represents a relatively unsatisfactory state of affairs such that a remedy must be created.

### SUMMARY OF THE INVENTION

The present invention provides for the integration of a check valve and a pressure sensor into one assembly and the creation of an integrated component from the check valve component and the pressure sensor or pressure switch component. This can be used to achieve a substantial cost reduction of the finished product for example by reducing the number of components and reducing the otherwise required interfaces. Furthermore, the required space can be reduced by integrating the check valve and pressure sensor system, i.e. pressure sensor or pressure switch, in a single component, and an increase in the production and manufacturing reliability can be achieved by reducing the number of required components. Since in addition a clear reduction of the assembly expenditure is achievable, the logistics expenditure is also reduced due to the lower number of components to be provided. It should furthermore be emphasized that in the case of a direct connection of the components to the pressure accumulator such as e.g. the brake booster or of the interface openings of another type of integration of the components, the number of receiving boreholes may now be reduced since only one component representing the check valve function and the pressure monitoring function is to be fixed in place or integrated.

In a preferred variant of idea at the basis of the present invention, a housing has two connecting pieces connected to it. The vacuum side of the pressure accumulator, such as e.g. of a brake booster, may be hooked up or connected to one of the two connected connecting pieces. The remaining connecting piece, fabricated e.g. as a plastic injection molded part, may be connected to a vacuum source by interconnecting a pressure sensor or a pressure switch. The vacuum prevailing in the pressure accumulator, e.g. a brake booster, may be maintained via a check valve, which is integrated in a connecting piece. The check valve, which is accomodated in the housing of the pressure sensor or pressure switch having an integrated check valve, separates a first flow cross section of the first connecting piece from a second flow cross section of the second connecting piece. The flow cross sections in the two connecting pieces may be identical to each other or may be configured to differ from each other. The check valve accommodated in the housing of the pressure sensor or of the pressure switch having an integrated check valve one the one hand eliminates a separate valve housing for the check valve, and using a single component it is possible to implement both the pressure monitoring of the pressure level in the pressure accumulator, such as e.g. of a brake booster, as well as the maintenance of the pressure level in the brake booster.

As another advantage of the approach provided according to the present invention it should be emphasized that the pressure sensor or pressure switch embedded into the housing may for example rest on the lateral surface of one of the two connecting pieces connected to the housing and thus record the pressure signal. The housing furthermore includes preferably a plug connector, via which the signal recorded by the pressure sensor or pressure switch may be supplied to a control unit. In a particularly simple manner from a standpoint of production engineering, the housing of the pressure sensor or of the pressure switch as well as the two connecting pieces injection molded onto this housing are manufactured by way of the plastic injection molding method. Without additional machining processes, this allows for example for stop faces to be injection molded on the lateral surface of the two connecting pieces, for the plug housing to be injection molded on the housing of the pressure sensor or pressure switch having an integrated check valve as well as for one or both of the mentioned connecting pieces to be injection molded on the housing as well for stop faces and retention ribs to be applied to them.

Furthermore, the fusion of a pressure sensor or pressure switch previously manufactured as a separate component with a check valve likewise previously manufactured as a separate component into one component has the advantage that now only one compact component has to be fastened to the housing of the pressure accumulator, such as e.g. of a brake booster, on which previously two separate units had to be fastened or integrated, such that connecting boreholes or connecting openings or the like previously provided on the housing of the pressure accumulator can now be elminated, which at least allows the housing of the pressure accumulator to be manufactured in a more simple manner, i.e. with less expenditure.

In motor vehicles operated by combustion engines whose induction pipe underpressures are not sufficient in all operating states for directly connecting a brake booster, or in motor vehicles having hybrid drives whose drives do not provide a direct underpressure for operating a brake booster, the approach provided according to the present invention moreover allows for the provision of a component to be mounted on the brake booster which continuously monitors the underpressure acting on the brake booster as well as the vacuum source providing the vacuum and at the same time maintains a vacuum prevailing at the pressure accumulator.

In another specific embodiment of the idea at the basis of the present invention, in addition to a one-piece construction, e.g. by plastic injection molding, of the housing together with the pressure sensor housing and one or both connecting pieces injection molded on it, i.e. permanently connected, it is possible to connect one or both connecting pieces e.g. by way of sealing adhesion or friction welding or another integral adhesion method to the housing of the pressure sensor or to use a form-locking joining method. According to this variant of an embodiment, advantageously a sealing element may be used, which is situated e.g. on the periphery of the piston-shaped valve body of the check valve and which is guided axially and radially within a annular recess of an annular space in the region of the check valve. Furthermore there is the possibility, in a one-piece construction of the housing having two connecting pieces injection molded on it, to fasten the sealing element within a connecting piece to an insert or to fasten the sealing element using a clip inserted into the connecting piece. The clip may be constructed in a particularly simple manner from the standpoint of production engineering as a separate component and may be fastened to one of the holding ribs formed on the outer peripheral surface of the connecting piece.

In another specific embodiment of the pressure sensor provided according to the present invention having an integrated check valve, the two connecting pieces may also be situated at a right angle with respect to each other. According to a specific embodiment to be described in more detail, one of the connecting pieces runs perpendicular to the pressure sensor, a perforation being produced in the wall of the latter, such as e.g. a perforated disk pattern. In a corresponding opening e.g. a connecting piece constructed as a separate component may be connected to the housing e.g. by way of laser welding or sealing adhesion. In this connecting piece to be fastened to the housing, the sealing element is embedded in the form of an annular diaphragm. Finally, another variant of an embodiment of the idea at the basis of the present invention provides for the annular diaphragm, which is used for sealing, as well as the valve body of the check valve to be integrated on the housing of the pressure sensor; in accordance with this specific embodiment, one of the connecting pieces being oriented e.g. perpendicular to the pressure sensor and the wall of the latter being provided with a perforation representing a perforated disk, which acts together with the sealing element in the form of an annular diaphragm.

### BRIEF DESCRIPTION OF THE DRAWINGS

FIG. 1 shows a specific embodiment of a housing of a pressure sensor having an integrated check valve and integrally connected additional connecting pieces shown in a sectional view.

FIG. 2 shows a specific embodiment of the idea at the basis of the present invention having a one-piece housing having two connecting pieces injection molded on it, in which a support bracing the sealing element in the form of an annular diaphragm is inserted into one of the connecting pieces.

FIG. 3 shows a sealing element support clipped into one of the connecting pieces of the one-piece housing.

FIG. 4 shows a specific embodiment of the approach provided according to the present invention having connecting pieces oriented at an angle with respect to each other.

FIG. 5 shows an exploded view of the specific embodiment shown in FIG. 4.

FIG. 6 shows another specific embodiment of the idea at the basis of the present invention having connecting pieces oriented at an angle with respect to each other, in this specific embodiment the sealing element in the form of an annular diaphragm being integrated on the pressure sensor housing with a connecting piece running perpendicular to the pressure sensor.

### DETAILED DESCRIPTION

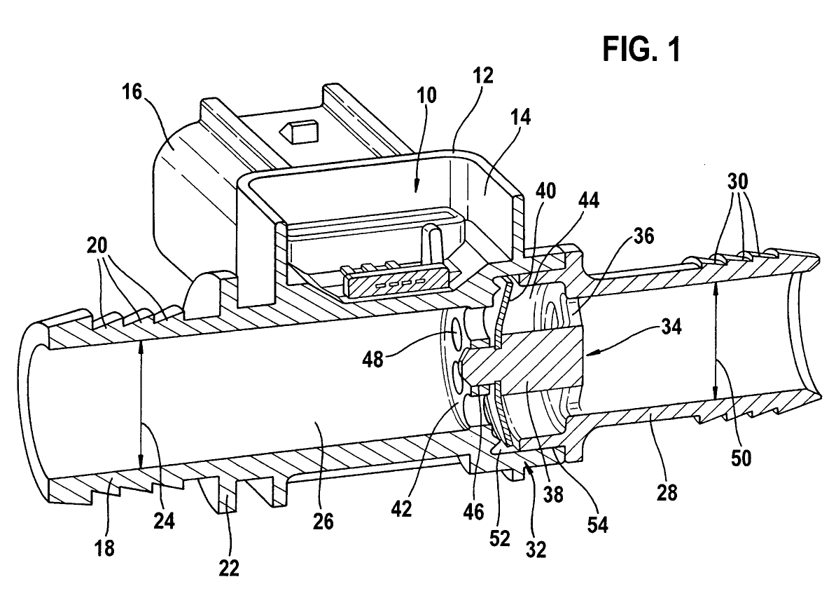

The representation in FIG. 1 shows a pressure sensor or a pressure switch 10 embedded in a housing 12 fabricated e.g. as a plastic injection molded part. Pressure sensor or pressure switch 10 is preferably embedded in a hollow space 14, which is enclosed by the wall of housing 12. Housing 12 of pressure sensor or pressure switch 10 has a plug connector 16 likewise injection molded on it, via which the signal of the pressure sensor or pressure switch 10 may be transmitted to an evaluation or control unit. Housing 12 of pressure sensor or pressure switch 10 contains a first connecting piece 18, to which a pressure accumulator such as e.g. a brake booster of a vehicle braking system may be connected. In this specific embodiment, housing 12 of pressure sensor 10 and first connecting piece 18 represent one component. On this there is a second connecting piece 28, which is used to connect a pressure source supplying the pressure accumulator. This pressure source can produce either an overpressure or also an underpressure in relation to the ambient pressure level.

The brake booster used by way of example in connection with the provided invention is in particular an underpressure brake booster, which is distinguished by its simple and inexpensive construction. In underpressure brake boosters, a pedal-side working diaphragm surface has outside air pressure applied to it as a function of the pedal force, while an underpressure is applied on the other side of the diaphragm. The force on the working diaphragm resulting from the pressure difference effects a force component supporting the exerted pedal force. The generated brake pressure results from the pedal force and the auxiliary force. In this connection, the auxiliary force component continuously increases in accordance with the constructively defined boost factor up to the saturation point. At the saturation point, the maximum pressure difference between the outside air pressure and the underpressure is reached.

The representation in FIG. 1 shows that for connecting the pressure accumulator that is supplied with underpressure, e.g. the brake booster, first connecting piece 18, which is an integral part of housing 12 of pressure sensor 10, has a number of annular holding ribs as well as an end stop 22 surrounding the outer lateral surface of first connecting piece 18. A first flow cross section of first connecting piece 18 is indicated by reference numeral 24. Reference numeral 26 designates the inner lateral surface of first connecting piece 18. First flow cross section 24 of first connecting piece 18 is separated from second flow cross section 50 of second connecting piece 28, which is sealingly bonded or integrally joined to housing 12 in another manner, by a check valve 32 separating connecting pieces 18, 28 from each other. Instead of an integral joining method, a form-locking or friction-locking joining method may be used as well. On the outer surface of second connecting piece 28 there are also a number of annular holding ribs 30, which are preferably injection molded on. Within housing 12 of pressure sensor or pressure switch 10, check valve 32 is located, which separates first flow cross section 24 in first connecting piece 18 from second flow cross section 50 in second connecting piece 28.

In the specific embodiment shown in FIG. 1, check valve 32 includes a disk 36 as well as a valve body 34. Valve body 34 is piston-shaped and acts together with a central opening 46 of a perforated disk 42. Perforated disk 42 moreover has a circle of perforations 48, which surrounds central opening 46. An annular space 44 surrounding valve body 34 in annular manner is located in check valve 32 between perforated disk 42 and guide disk 36. Annular space 44 contains a sealing element 40 in the form of an annular diaphragm, which is accommodated on the periphery of piston-shaped valve body 34. Sealing element 40 is embedded on the periphery in a groove of annular space 44 and is guided axially. Sealing element 40 in the form of an annular diaphragm is located in front of perforated disk 42 having central opening 46 and assumes the sealing function.

FIG. 1 reveals that housing 12 and first connecting piece 18 and check valve 32 integrated into housing 12 represent one component. The approach provided according to the present invention brings together in one single component components that were previously constructed separately: check valve 32 and pressure sensor or pressure switch 10. The integrated component offers the possibility, on the one hand, of monitoring the pressure level (overpressure/underpressure) or the vacuum in the pressure accumulator, e.g. brake booster, via pressure sensor 10 accomodated in hollow space 14, and, on the other hand, of ensuring the maintenance of the pressure level prevailing in the pressure accumulator (brake booster) via check valve 32. The approach provided according to the present invention fuses the two separate components used in previous approaches into one component.

In motor vehicles operated by combustion engines whose intake pipe underpressures are not sufficient in all operating states for directly connecting a brake booster, or in motor vehicles having hybrid drives whose drives do not provide a direct underpressure for operating a brake booster, integrated pressure sensor or pressure switch 10 provided according to the present invention, which includes check valve 32 in its housing 12, offers the advantage that, using the provided assembly, it is possible to provide an integrated pressure sensor or pressure switch 10, which continuously monitors the pressure level or vacuum prevailing in the pressure accumulator (brake booster). The use of integrated pressure sensor or pressure switch 10 having check valve 32 provided according to the present invention on the one hand reduces the assembly expenditure due to a fusion of the functions of pressure monitoring and pressure level maintenance in the pressure accumulator, e.g. of a brake booster, by one component and allows for example in motor vehicle applications for a smaller dimensioning of the pressure accumulator, e.g. of a brake booster. The use of the assembly of an integrated pressure sensor 10 provided according to the present invention moreover allows for a continuous monitoring of a brake booster coupled on combustion engines or in hybrid drives to a vacuum source with respect to the current pressure level produced in these.

FIG. 1 shows that integrated pressure sensor 10 may be manufactured as a plastic injection molded component. The construction of integrated pressure sensor or pressure switch 10 as an injection molded component, i.e. having housing 12, first connecting piece 18 and second connecting piece 28 as one component as well as check valve 32 integrated therein, may be manufactured in a particularly simple and cost-effective manner by way of the plastic injection molding method. In particular, when fabricating housing 12, the slide-on bevels, stop faces 22 and holding ribs 20 and 30 provided on first connecting piece 18 and on second connecting piece 28 respectively may be manufactured in a particularly simple manner in one operation. Something analogous applies to hollow space 14, which is formed in the interior of housing 12 of integrated pressure sensor 10 and which accommodates pressure sensor or pressure switch 10. It emerges from FIG. 1 that pressure sensor or pressure switch 10 may be situated on the outer wall of first connecting piece 18. The design of housing 12 of integrated pressure sensor 10 as a plastic injection molded component advantageously allows for plug connector 16, via which pressure sensor 10 is able to be electrically contacted, to be injection molded on housing 12 likewise in the injection molding operation.

While in the specific embodiment of integrated pressure sensor 10 shown in FIG. 1 first flow cross section 24 and second flow cross section 50 in connecting pieces 18 and 28 respectively correspond to each other, first flow cross section 24 and second flow cross section 50 may also be dimensioned differently, i.e. have different cross sectional areas.

The specific embodiment shown in FIG. 1 furthermore shows that sealing element 40 in the form of an annular diaphragm is accommodated on the periphery of valve body 34 configured in a piston shape 38. The periphery of sealing element 40 is fixed in a revolving groove 52 in the axial direction. Valve body 34 configured in a piston shape 38 is centered in the central opening 46 of perforated disk 42. Moreover, valve body 34 is fixed in disk 36; FIG. 1 showing further that second connecting piece 28 is connected at a joint 54 to housing 12 of integrated pressure sensor 10. Second connecting piece 28 may be joined to housing 12 of integrated pressure sensor 10 at joint 54 e.g. by a sealing adhesive or by another integral method. Instead of an integral joining method, a form-locking or friction-locking joining method may also be chosen for joining connecting pieces 18 and 28 to housing 12. In the specific embodiment of the idea at the basis of the present invention as shown in FIG. 1, housing 12 includes, in addition to housing 12 for receiving the pressure sensor, first connecting piece 18, which extends to a pressure accumulator, e.g. the brake booster, of a braking system of a vehicle.

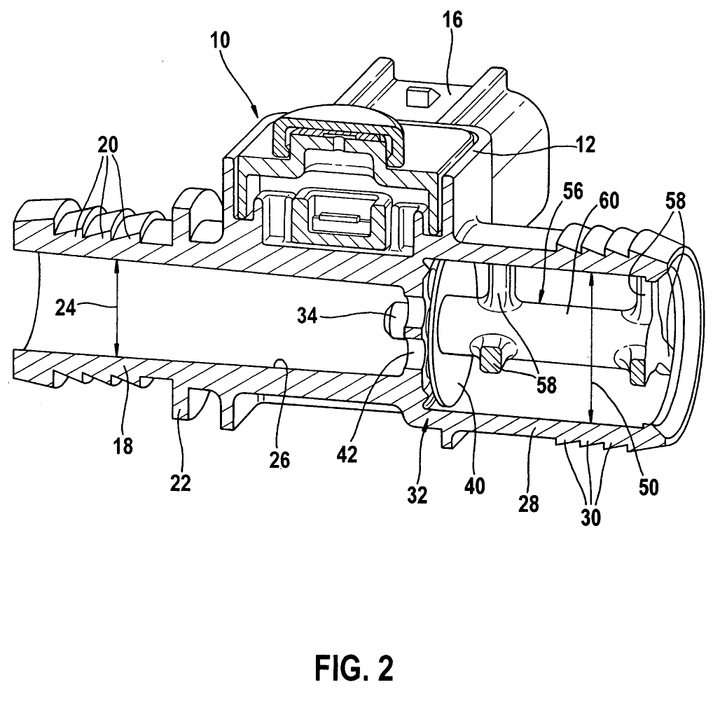

FIG. 2 shows another specific embodiment of the idea at the basis of the present invention of an integrated pressure sensor.

FIG. 2 shows that housing 12 of integrated pressure sensor 10, first connecting piece 18 as well as second connecting piece 28 represent an integral component fabricated as a single piece. Due to its relatively complex geometry, this component may be fabricated advantageously by way of the plastic injection molding method. The plastic injection molding method eliminates the need for joint 54, which is required in the first specific embodiment between housing 12 of integrated pressure sensor 10 and second connecting piece 28. Via the plastic injection molding method it is possible in an advantageous manner to form on the outer lateral surfaces of first connecting piece 18 and of second connecting piece 28 annular stop face 22 and holding ribs 20 and 30 in the slide-on bevels that respectively seem suitable. This may be done within one operation, additional machining of the one-piece housing together with first connecting piece 18 and second connecting piece 28 no longer being necessary.

The representation according to FIG. 2 shows that first connecting piece 18 and second connecting piece 28 respectively have flow cross sections 24 and 50, which differ from each other. In the specific embodiment shown in FIG. 2, second flow cross section 50 of second connecting piece 28 is chosen to be larger than flow cross section 24 of first connecting piece 18, since in second flow cross section 50 of second connecting piece 28 according to the specific embodiment in FIG. 2 a support 56 is integrated. Support 56 includes at least one support star 58, by which support 56 is fixed in the interior of second connecting piece 28, braced on its interior lateral surface. Support 56 includes a support body 60, which is essentially pin-shaped and on whose end pointing to first connecting piece 18 sealing element 40 is accommodated in the form of an annular diaphragm. Support body 60 moreover accommodates valve body 34 in the shape of a piston 38, which represents check valve 32. Furthermore, at the transition point from second connecting piece 28 to first connecting piece 18 there is perforated disk 42 mentioned already in connection with the first specific embodiment in FIG. 1, which has a circle of perforations 48 as well as central opening 36.

In a particularly simple manner from the standpoint of assembly technology, support 56 together with its at least one support star 58 may be clamped into the interior of second connecting piece 28.

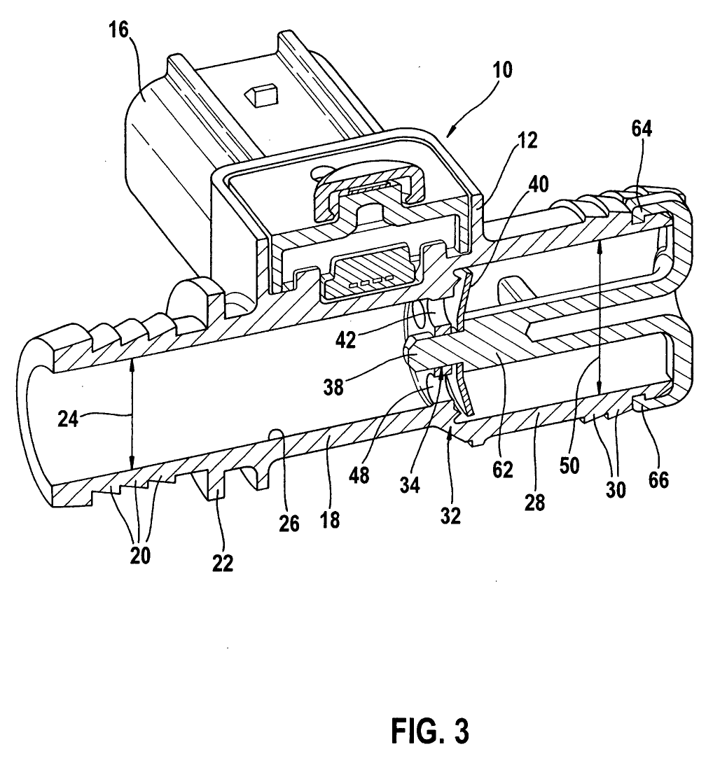

From the representation shown in FIG. 3, another specific embodiment of the integrated pressure sensor provided according to the present invention may be gathered, in which the first connecting piece, the second connecting piece and the housing represent one component.

It emerges from the schematic sectional view shown in FIG. 3 that integrated pressure sensor 10 includes housing 12, on which, preferably by way of the plastic injection molding method, first connecting piece 18 and second connecting piece 28 are already injection molded. According to this manufacturing method, it is possible to form in housing 12 in a particularly simple manner hollow space 14, in which the pressure sensor is embedded. In the perspective sectional view shown in FIG. 3, the pressure sensor is assigned to the lateral surface of first connecting piece 18. Holding ribs 20 and end stop 22 are injection molded on the periphery of first connecting piece 18. There are a number of consecutive holding ribs 30 on the periphery of second connecting piece 28. Flow cross sections 24 and 50 of first and second connecting piece 18, 28 respectively are chosen in different dimensions in this specific embodiment as well since a fixing clip 62 is embedded in second flow cross section 50 of second connecting piece 28. Fixing clip 62 has essentially a pin-shaped appearance and has on its end pointing to first flow cross section 24 of first connecting piece 18 valve body 34 configured in a piston shape 38. Moreover, sealing element 40 in the form of an annular diaphragm is accommodated on the periphery of valve body 34 configured in a piston shape 38. Pin-shaped fixing clip 62 is locked with the aid of a first hook 34 and a second hook 66 in one of holding ribs 30 on the periphery of second connecting piece 28. Furthermore, at least one spacer pin, which is braced on the inner lateral surface of second connecting piece 28, may be provided on the periphery of the body of fixing clip 62 enclosed by second connecting piece 28. The fixing clip represented in the specific embodiment shown in FIG. 3 is simply inserted into second flow cross section 50 of second connecting piece 28, is fixed on at least one holding rib 30 via first and second hook 64, 66, and is centered by insertion into perforated disk 42 at the transition point to first connecting piece 18 using valve body 34.

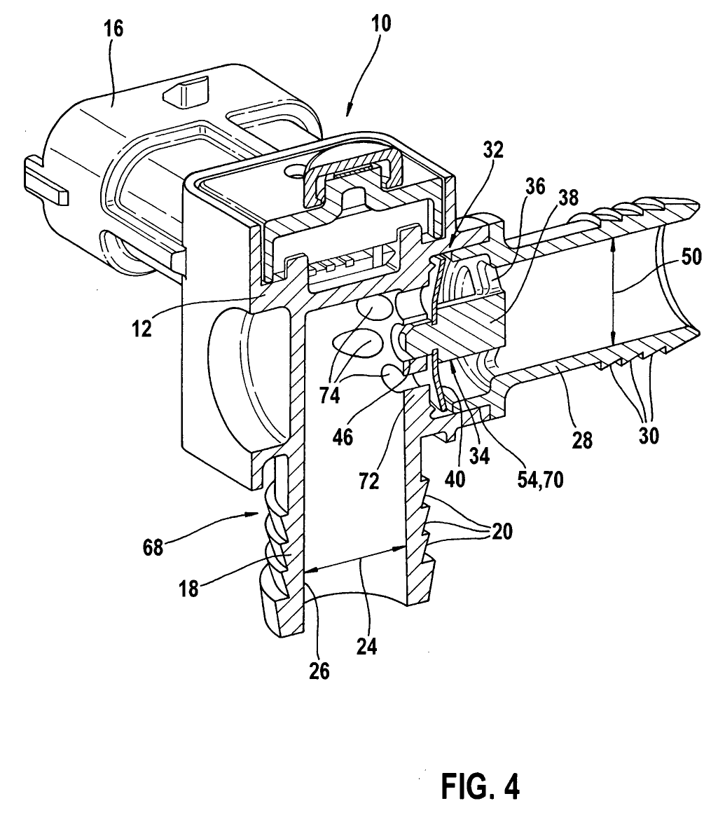

FIG. 4 shows another embodiment variant of the integrated pressure sensor provided according to the present invention, in which the connecting pieces enclose a 90° angle in relation to each other.

The representation according to FIG. 4 shows that first connecting piece 18 disposed within housing 12 is oriented in a perpendicular orientation 68 with respect to the course of second connecting piece 28. In the specific embodiment represented in FIG. 4, first flow cross section 24 of first connecting piece 18 corresponds to second flow cross section 50 of second connecting piece 28. This is joined at a joint 70 e.g. to housing 12 of integrated pressure sensor 10. The joining may be done e.g. by sealing adhesion or by another integral method. Within second flow cross section 50 of second connecting piece 28 there is disk 36, on which valve body 34 configured in a piston shape 38 is accommodated. Sealing element 40 in the form of an annular diaphragm is located on the periphery of valve body 34 configured in a piston shape 38. Valve body 34 configured in a piston shape 38 is accommodated in a central opening 46 of wall 72 of first connecting piece 18. Holding ribs 20 can be seen on the outer lateral surface of first connecting piece 18. Holding ribs 30 likewise surround the outer lateral surface of second connecting piece 28, which is joined at a joint 70 to housing 12 of integrated pressure sensor 10. Perforated disk 42 is eliminated in the specific embodiment of integrated pressure sensor 10 shown in FIG. 4. Its function is performed in the specific embodiment represented in FIG. 4 by a hole pattern in wall 72 of first connecting piece 18 running in perpendicular orientation 68.

The specific embodiment represented in FIG. 4 is able to accommodate special structural conditions for applying an overpressure or an underpressure on a pressure accumulator such as e.g. the brake booster of a braking system of a motor vehicle. It is irrelevant whether the integrated pressure sensor 10 represented in FIG. 4 is assigned to an overpressure or an underpressure source.

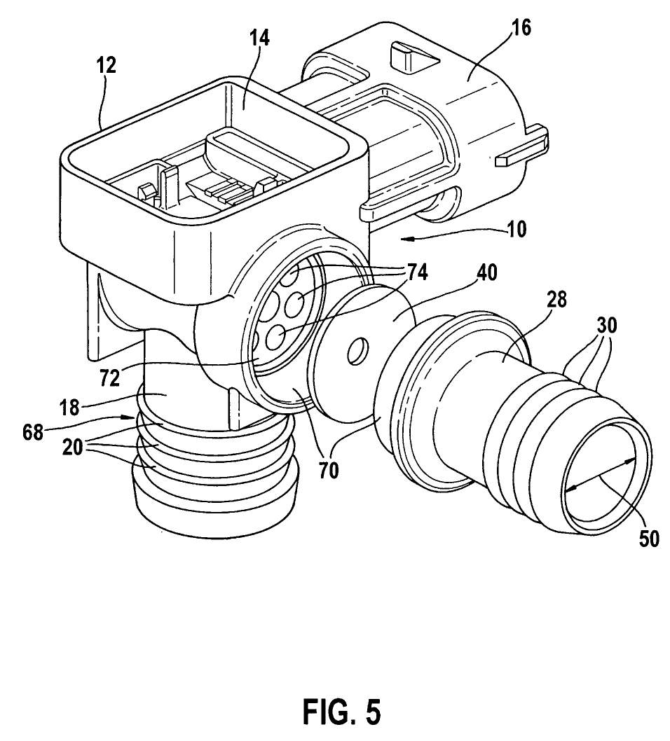

FIG. 5 shows an exploded view of the specific embodiment of the integrated pressure sensor represented in FIG. 4.

It may be gathered from FIG. 5 that hole pattern 74 is formed in the wall of first connecting piece 18 formed in a perpendicular orientation 68. Hole pattern 74 is surrounded by a collar-shaped ring, which accommodates annular diaphragm 40. Annular diaphragm 40 in turn is fixed in central opening 46 of wall 72 by valve body 34 configured is a piston shape 38 in the interior of second connecting piece 28. Following the insertion of second connecting piece 28 into its joint 70, it may be joined to housing 12 of integrated pressure sensor 10 by way of a sealing adhesion or by another integral method. Instead of a integral joining method, a form-locking or friction-locking joining method may be used as well. Holding ribs 20, 30, which are equipped with a bevel e.g. suitable for sliding on a hose connection, run on both the outer lateral surface of first connecting piece 18 as well as on the outer lateral surface of second connecting piece 28. The perspective exlosive view according to FIG. 5 additionally shows that housing 12, in which first connecting piece 18 is disposed, has a hollow space 14 for receiving the pressure sensor component and that plug connector 16 is injection molded on the latter.

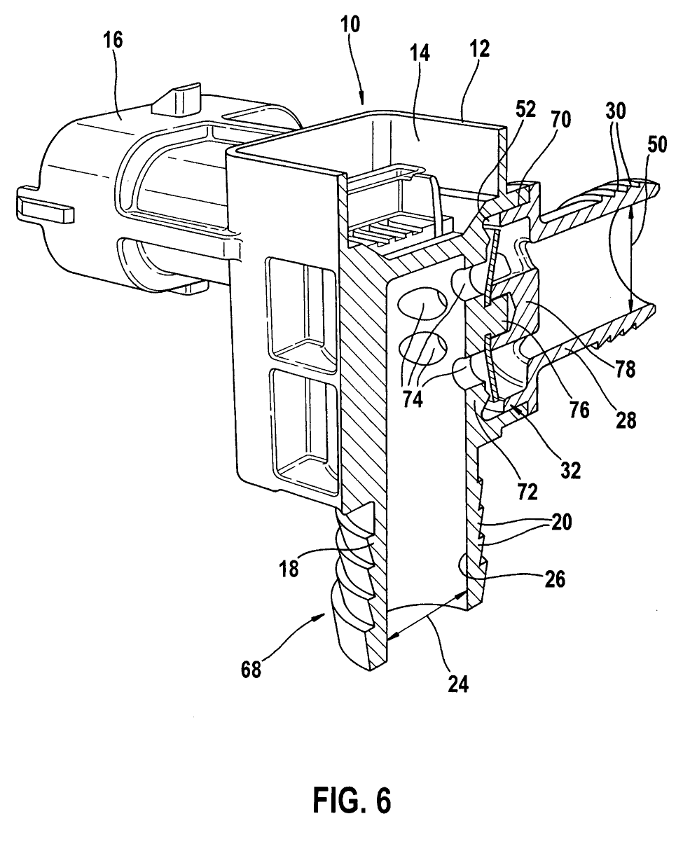

Another specific embodiment of the idea at the basis of the present invention may be gathered from the representation shown in FIG. 6, in which the connecting pieces run at an angle with respect to each other.

In contrast to the specific embodiment represented in FIG. 4 in a perspective section, in the representation shown in FIG. 6, a support spike 36 is injection molded on or embedded into wall 72 of first connecting piece 18 running in perpendicular orientation 68. This is surrounded by hole pattern 74. The annular diaphragm representing sealing element 40 is slid onto support spike 46 formed in wall 72 and is fastened on support spike 46 by a fastening element 78. In the specific embodiment of the idea at the basis of the present invention represented in FIG. 6, second connecting piece 28 is connected to housing 12 of integrated pressure sensor 10 on joint 70 by way of sealing adhesion or another integral joining method. Instead of an integral joining method, a form-locking or friction-locking joining method may be used as well. Moreover, plug connector 16 is formed on housing 12, which receives first connecting piece 18 running in perpendicular orientation 68. In the specific embodiment represented in FIG. 6, check valve 32 and the sealing element are integrated in housing 12 of integrated pressure sensor 10 in addition to plug connector 16 and first connecting piece 18—designed here in perpendicular orientation 68. Only second connecting piece 28 is joined to housing 12 at joint 70. In the specific embodiment of the idea at the basis of the present invention represented in FIG. 6, first flow cross section 24 of first connecting piece 18 and second flow cross section 50 of second connecting piece 28 correspond to each other. Holding ribs 20, 30 are injection molded on both connecting pieces 18 and 28 respectively, which can be fabricated in a particularly simple manner if housing 12 as well as second connecting piece 28 are fabricated as a plastic injection molded part.

In addition to the above-described specific embodiments of sealing element 40 as an annular diaphragm, sealing element 40 may also take the form of a sphere. Using a spherical sealing element 40 it is possible to close the sealing surface, such as e.g. central opening 46 in perforated disk 42 or central opening 46 in hole pattern 74, in the specific embodiment shown in FIG. 4, such that the flow cross section is closed by check valve 32. Both the design as an annular diaphragm as well as the design as a spherical body as sealing element 40 are possible.

1. A pressure sensor for detecting one of an overpressure and an underpressure, comprising:
a housing including a first connecting piece, the housing further including a check valve and a second connecting piece for a pressure source; and
at least one of a pressure sensor and a pressure switch embedded in the housing.

2. The pressure sensor according to claim 1, wherein the pressure sensor is for detecting the one of the overpressure and the underpressure on a pressure accumulator.

3. The pressure sensor according to claim 1, wherein the check valve integrated into the housing is situated between a first flow cross section and a second flow cross section.

4. The pressure sensor according to claim 1, wherein a valve body of the check valve is accommodated in one of the connecting pieces.

5. The pressure sensor according to claim 1, wherein the check valve has a valve body, which is centered by a central opening of a perforated disk or a wall formed in one of the connecting pieces.

6. The pressure sensor according to claim 1, wherein the housing has a hollow space, a bottom of which is formed by a lateral surface of one of the connecting pieces.

7. The pressure sensor according to claim 1, wherein the housing is produced as a plastic injection molded component as one component and includes a plug connector that is injection molded on.

8. The pressure sensor according to claim 1, wherein the second connecting piece is joined to the housing at a joint in one of an integral and form-locking manner.

9. The pressure sensor according to claim 1, wherein the housing in an area of the check valve includes an annular space, in which a sealing element in the form of an annular diaphragm is situated.

10. The pressure sensor according to claim 3, wherein the first flow cross section is identical to the second flow cross section.

11. The pressure sensor according to claim 3, wherein the first flow cross section is different from the second flow cross section.

12. The pressure sensor according to claim 1, wherein the first connecting piece and the second connecting piece run at an angle with respect to each other.

13. The pressure sensor according to claim 1, wherein the first connecting piece and the second connecting piece run coaxially with respect to each other.

14. The pressure sensor according to claim 9, wherein the sealing element is accommodated on one of (a) a valve body of the check valve, (b) a support body, which is clamped into one of the connecting pieces, and (c) a pin-shaped fixing clip.

15. The pressure sensor according to claim 9, wherein the sealing element is fixed in the housing on a support spike using a fastening element.

16. The pressure sensor according to claim 4, wherein the valve body is formed in an axially movable manner, is guided in a flow cross section and, when a relative overpressure occurs, is pressed against a sealing surface and closes the flow cross section.

17. The pressure sensor according to claim 1, wherein the pressure sensor is used on a pressure accumulator of a brake booster of a braking system of a motor vehicle.
